(19) United States
(12) Patent Application Publication
(10) Pub. No.: US 2014/0282827 A1
(43) Pub. Date: Sep. 18, 2014

(54) METHOD AND APPARATUS FOR SECURE DATA TRANSFER PERMISSION HANDLING

(71) Applicant: FORD GLOBAL TECHNOLOGIES, LLC, Dearborn, MI (US)

(72) Inventors: David Chase Mitchell, Dearborn, MI (US); Julius Marchwicki, Dearborn, MI (US); Michael Raymond Westra, Plymouth, MI (US); Elizabeth Halash, Dearborn, MI (US)

(73) Assignee: FORD GLOBAL TECHNOLOGIES, LLC, Dearborn, MI (US)

(21) Appl. No.: 13/838,583

(22) Filed: Mar. 15, 2013

(51) Int. Cl. G06F 21/62; H04L 29/06

(52) U.S. Cl. CPC G06F 21/6218; H04L 63/20
USPC 726/1

(57) ABSTRACT

A vehicle-based system includes a processor configured to receive policy table updates issued from a remote server. The processor is further configured to update a local policy table based on the updates. The processor is additionally configured to receive a request from a remote application for data access. The processor is further configured to determine, based on the local policy table, if the data access requires user consent. The processor is also configured to determine if required consent is stored in the local policy table and provide data access to the remote application based on stored required consent.

### TECHNICAL FIELD

The illustrative embodiments generally relate to a method and apparatus for secure data transfer permission handling.

### BACKGROUND

Smart phones, tablet PCs, laptops and other portable devices are more and more capable of interfacing with other remote computing systems, such as, but not limited to, a vehicle infotainment system. In particular, as the computing and communication capabilities of infotainment systems grow, it may be desirable to have these systems interface with and exchange information with remote devices and applications running on remote devices.

In some instances, transfer of information may include transfer of secure or quasi-secure information, such as, but not limited to, a VIN, a driver identification, a driver location, etc. Further, with respect to the transfer of certain types of information, it may even be mandated that the information not be transmitted without some form of driver permission.

### SUMMARY

In a first illustrative embodiment, a vehicle-based system includes a processor configured to receive policy table updates issued from a remote server. The processor is further configured to update a local policy table based on the updates. The processor is additionally configured to receive a request from a remote application for data access. The processor is further configured to determine, based on the local policy table, if the data access requires user consent. The processor is also configured to determine if required consent is stored in the local policy table and provide data access to the remote application based on stored required consent.

In a second illustrative embodiment, a computer-implemented method includes receiving policy table updates issued from a remote server. The method also includes updating a local policy table based on the updates. The method further includes receiving a request from a remote application for data access. The method additionally includes determining, based on the local policy table, if the data access requires user consent. Also, the method includes determining if required consent is stored in the local policy table and providing data access to the remote application based on stored required consent.

In a third illustrative embodiment, a non-transitory computer-readable storage medium stores instructions that, when executed by a processor, cause the processor to perform a method including receiving policy table updates issued from a remote server. The method also includes updating a local policy table based on the updates. The method further includes receiving a request from a remote application for data access. The method additionally includes determining, based on the local policy table, if the data access requires user consent. Also, the method includes determining if required consent is stored in the local policy table and providing data access to the remote application based on stored required consent.

### BRIEF DESCRIPTION OF THE DRAWINGS

FIG. 1 shows an illustrative vehicle computing system;

FIGS. 2A-2D show an illustrative example of a comprehensive, non-limiting permission handling system; and

FIG. 3 shows an illustrative example of a permission handling process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

New state and federal legislation may call for vehicle owners to explicitly authorize the sharing of vehicle data with other devices. This can provide an added layer of protection against unauthorized data removal, and can serve to protect legally mandated privacy rights. The scope and nature of these requirements, however, may be rather dynamic in form, and compliance could result in a number of updates and changes to existing protocols, on a continuous basis.

According to the illustrative embodiments, an administrator can update and define data types and application procedures requiring authentication, save and compile records of authentication approval, and generally facilitate user consent to data transfer. Consent agreements can be delivered and collected at a vehicle, but can be defined remotely based on current standards.

Changes to consent agreements and data types can be handled remotely independent (if desired) of software updates. Further, records of consent can be stored remotely for delivery on demand through interface systems, such that even if a vehicle changes hands, or the consent agreements are otherwise inaccessible, records of the consent can be preserved.

FIGS. 2A-2D show an illustrative example of a comprehensive, non-limiting permission handling system. FIG. 2A shows processes and data handling in a vehicle computing system module, with the rectangles representing data elements and the ovals representing process steps.

In this illustrative, non-limiting example, a driver launches an application 201 on a remote device connected to a vehicle computing system, in this case through use of the vehicle computing system. Launching the application passes application credentials 202, a consent record 203 (established when the user provides permission to transfer data to the application), and, if needed, an application registration request 235 (FIG. 2B).

The application credentials are passed to a process that verifies the access permissions of a particular application 206. Since varied applications have varied permissions, with respect to accessible data types, accessible vehicle systems, API function usage rights, etc., the process may check and/or set the permissions for the particular application being launched.

Verifying the application access permissions 206 may also send a launch request 210 to a process for configuring an application context 211. This context configuration 211 may help establish application priorities and access rights. The context configuration 211 may pass usage and error data 209 (while the application is in use) to a process for updating and replacing a local policy table 208. The local policy table update/replace process 208 may also receive data in the form of a consent record 203 resulting from the application launch 201, device data 217 relating to the wirelessly connected mobile device, and updated policies 216 resulting from communication with a remote server for policy configuration, which will be discussed later in greater detail.

The context configuration process 211 may further pass any remote procedure calls (RPCs) 213 and LUA libraries 212, both to a process for facilitating application communication and execution 214. The RPCs and libraries can assist the application in execution and communication when running in conjunction with the vehicle computing system (VCS).

Additionally, the context configuration process 211 may pass a message code 226 for delivery to a driver (alone or in conjunction with other message codes). Finally, in this illustrative example, the context configuration process 211 may send a notification of any permissions changes to a mobile device, discussed with respect to FIG. 2B.

Local policy changes can be implemented through a remote server in communication with the vehicle computing system through a nomadic device. Aspects of this control are discussed with respect to FIGS. 2A-2D, in conjunction with other functionality. In this figure, a response handling process 227 (handling an incoming policy update, in this portion of the example) receives a message including any policy changes.

If the message includes any message codes for the driver 226, those can be sent to message delivery 225. At the same time, any messages for the VCS 224 can be passed to a local message handling process 222. Since the messages 224 may be secure, the local message handling process 222 can authenticate, decrypt and decode the incoming messages as needed. The unencrypted, authenticated, decoded message 221 can then be passed to a process to validate message identifiers 220.

The validation process 220 can pass any received, updated policies 216 to a process for updating policies 208. This helps ensure that the policies, as defined remotely, are implemented on the vehicle when sent to the vehicle, thus assisting in maintaining compliance. The updated policies can also be passed to a local policy table 207, for use by both the verification of access permissions process 206 and as a response to a request for policy table replacement 205 issued to the remote server (discussed later herein). The policy table replacement request may be implemented, for example, in response to an Nth key-on event or under other suitable protocol. It can also receive a snapshot of local policies 204 (currently in place) and pass those along 215 with the request so that the remote server receives an accurate snapshot of local policies as well as any consent records 203 in the local policy table as updated by the policy table update process 208.

The local policy update process 205 can pass a request to a message handling routine 218, which can pass any message identifiers 219 to a message security module. The message security module will also receive message identifiers from the validation process 220. Additionally, the validation process may pass a message code 223 for delivery to a driver 225 if required.

The message handling routine 218 can pass a message 228 (for example, the update policy request) to a message queuing module for delivery to a remote server when a connection is available and the message “turn” in the queue is up. The message queuing module can queue outgoing messages 229 and pass the updated queue 230 to an outgoing message sending process 231. The sending process 231 can then send the outgoing message at an appropriate time. Since a connection to the remote server may not always be established, and since multiple systems may attempt to send outgoing messages, the queue can assist in prioritizing and delivering messages with an emphasis on proper delivery order (if desired).

FIG. 2B shows a mobile device and a remote software module for secondary message/request flow handling. Both are exemplary and non-limiting and are provided for illustrative purposes only. The mobile device, in this example, provides a communication connection for the VCS from FIG. 2A to talk to a remote server discussed later. Accordingly, it receives and passes a number of data elements from/to the VCS and from/to the secondary handling module.

In this example, an RPC 232 (such as, for example, a request for an updated policy table) is passed to the mobile device. This asynchronous message 232 is received by the device 236 and a VCS message 241 can be included as part of the message. The VCS message may, if required/desired, be routed 240 to a third party, in which case the message 246 is sent to the appropriate party.

In addition or alternatively, the message 241 may be sent to a forwarding process 247. The forwarding process can be provided as part of an OEM code library/application residing on the mobile device, provided for the purpose of communicating to/from the remote server. The message 249, in an encrypted, encoded, signed form, if desired, can be sent to the secondary handling process for further processing.

The secondary handling process can receive the message and validate any message identifiers 251. A validated message 252 can then be sent to another forwarding process 255, for relay to the remote server. One or more message identifiers 253 may also be passed to an error handling process, if an error is identified, for example, to generate an error code for a module 256.

This same secondary process can receive incoming messages from the server (such as those containing updated policy tables, for example) and route the messages to a mobile application 254. Again, if any message identifiers 253 indicative of error states are included with these server-sent messages, they can be handled by the error coding process 256.

Returning messages for the VCS 250 can be sent to the OEM applications/code residing on the mobile phone, which receives and prepares to forward the message to the VCS 248. The encrypted, signed, encoded message 242 can be sent as part of an RPC 237 to an appropriate module on the VCS. The RPC call and accompanying data 233 can be sent, for example, to the message handling process on the VCS.

Additionally, any permission change notifications identified by VCS processes 234 can be sent to the mobile device. These permission changes may impact a particular application's ability to interact with the VCS. The permissions changes 234 may be received by the OEM library process for handling these changes 238, and the mobile application may then be handed a set of permissions 243 as defined/identified by the VCS.

Further, a process running on the mobile device may (at some point not necessarily related to the other processing) establish communication with the VCS 245. In at least one example, communication establishment processes may be run prior to other communication with the VCS. The credentials of one or more mobile applications 244 may reside on the mobile device and may be passed to an OEM library process for registering a mobile application interface 239. The registration request and any response from the VCS 235 may be passed as needed between the VCS and the mobile device.

FIG. 2C shows an illustrative example of several remote (OEM-side) processes for message handling. In this illustrative example, a message 257 (such as, for example, a message requesting a policy table update) has been passed from the secondary handling process and is received by an OEM side process that unwraps the message 261. The message, in a decoded, decrypted, authenticated form 260, is then routed appropriately 262. For example, in this illustrative embodiment, a local policy table replacement request 264 is sent to a remote server designated for handling such requests.

The message can also be sent to a IVSS system for decoding 269 and encoding 268. Using a signature key 272 sent 271 from a GIVIS system, the process can take the key 270 and use it for message 266, 267 decoding 269 and encoding 268.

Also, any outgoing messages from the server may be handled here, such as, for example, an updated policy table 265 responsive to the update request. The message handling process can wrap the message (encode, encrypt and sign) and send the message to the secondary handling process for appropriate routing, delivery and error detection.

Finally, message codes from the backend error coding 258 can be received by the OEM message handling process and can be wrapped 263 for appropriate delivery to other remote systems and/or back to the VCS for handling/reporting.

FIG. 2D shows a backside server arrangement for message handling, in this case, handling of policy table updates and consent logging. Messages, such as policy table requests, consent agreements, usage data, etc. are received by the server. Any replacement policy tables are prepared as needed 274, for eventual delivery to the VCS. A local policy table snapshot (local to the vehicle) 273 is sent, which may contain, among other things, consent records, usage data and device data.

VCS device data can be extracted 277 from the policy table snapshot and the device data 280 can be used by an administrator to view a device usage report 288. Mobile application usage and/or error data can also be extracted 278, and the usage/error data 281 can be used by the administrator to view statistics/information on application usage and error data 289. Also, in this example, consent data may be extracted and stored 279. This provides a remote backup of consent records. At such time as desired, the stored consent records 282 can be viewed 290 by the administrator or any other party requesting evidence of consent agreements.

Additionally, in this example, an administrator is responsible for maintaining and updating information relating to the policy table. For example, without limitation, the administrator may manage consent groupings 291. These groupings, among other things, can specify various types of data that require consent agreements, and can be updated in accordance with OEM policy, government standards or in accordance with other suitable policy (e.g., without limitation, user mandated “safe” data).

The administrator can further manage development electronic serial numbers 292. Further, when developers create new software for interaction with a VCS, that software may require some form of license to utilize certain aspects of the VCS or access certain data. License requests can be approved by the administrator 293. Message code mappings 294 may further be handled by the administrator, as well as message module configuration parameters 295.

All of the various aspects of the VCS control systems that can be managed by the admin can be utilized by a local policy update process 274 for preparing an updated policy table. For example, without limitation, consent groupings 283, development module listings 284, a master policy table 285 containing information such as, but not limited to, license approvals, message code mappings 286 and module configuration parameters 287 may all be fed into the local policy update process 274 for creating an updated local policy table. The updated local policy table 275, once prepared, can be sent 276 back to the VCS as a replacement policy table.

Although merely illustrative and non-limiting, and further non-exhaustive, this example shows at least one relatively comprehensive instance of a robust system for handling consent policy creation, presentation and information gathering.

FIG. 3 shows an illustrative example of a permission handling process. In this illustrative example, a user attempts to access an application that requires, among other things, access to some form of sensitive data 301. Sensitive data includes, for purposes of this example, data that, for one reason or another, requires consent of a user prior to transfer to a remote requestor from a vehicle.

In this illustrative procedure, the process receives one or more requirements (for example, without limitation, from a remote server) for handling of the sensitive data 303. A local policy table (which may include a recently updated local policy table) is checked 305 to see if a consent entry already exists for this application and data 307. In other words, has the user previously provided consent for this data to be transferred to this application.

If no entry exists, consent will be needed, so an entry is added to the local policy table 309 in which consent (or lack thereof) can be recorded. If the consent entry exists, it is possible that a policy with respect to that data or application has changed. For example, without limitation, it is possible that additional data requested by the application is now subject to a consent requirement. If any new policies do not match old policies 313 (for which consent may have been previously obtained), the process proceeds to update a consent policy in the table 311 to bring the policy for that application up to date.

If consent was not present, or if the policies had changed, the process will then request consent from the user 315. In some instances, the consent request may be part of an application launch, in other instances it may be explicitly required as a secondary request. If the consent is given 323, the process may then proceed to update a consent log as part of the policy table 325. If the consent is not given, the process may additionally update the consent log 327 and then may deny the application access to the particular data 329. What effect this has on a given application may be application dependent.

On the other hand, it may be the case that previous consent entries and policies match existing protocol. In such a case, the process may check to see if consent was, in fact given previously 317. In this example, even if a user denied access previously, the consent request is represented, in case the user changes their mind. In other instances, the previous rejection may serve for later rejections.

Once consent is given (or recognized from a previous instance), the process can log any usage data about the application being run 319. At the same time, if any access to secure data is requested, the process can allow access to the data in accordance with the provided consent 321. At some point, it may also be desirable to have the process report 331 any logged usage data, policy table changes, etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle-based system comprising:
a processor configured to:
receive policy table updates issued from a remote server;
update a local policy table based on the updates;
receive a request from a remote application for data access;
determine, based on the local policy table, if the data access requires user consent;
determine if required consent is stored in the local policy table; and
provide data access to the remote application based on stored required consent.

2. The system of claim 1, wherein the remote server is an OEM-controlled server.

3. The system of claim 1, wherein the policy table updates include changes in secure data definitions.

4. The system of claim 3, wherein secure data definitions relate to secure data including data requiring user permission for transfer from a vehicle to a remote device.

5. The system of claim 1, wherein the request from the remote application is received from a device wireless connected to the processor.

6. The system of claim 1, wherein the processor is further configured to request user consent and store a response to the request in the local policy table.

7. The system of claim 6, wherein the stored required consent resulted from a user consent request issued during a previous communication session between the processor and the remote application.

8. The system of claim 6, wherein the processor is further configured to report the stored response to the remote server.

9. A computer-implemented method comprising:
receiving policy table updates issued from a remote server;
updating a local policy table based on the updates;
receiving a request from a remote application for data access;
determining, based on the local policy table, if the data access requires user consent;
determining if required consent is stored in the local policy table; and
providing data access to the remote application based on stored required consent.

10. The method of claim 9, wherein the remote server is an OEM-controlled server.

11. The method of claim 9, wherein the policy table updates include changes in secure data definitions.

12. The method of claim 11, wherein secure data definitions relate to secure data including data requiring user permission for transfer from a vehicle to a remote device.

13. The method of claim 9, wherein the request from the remote application is received from a device wireless connected to the processor.

14. The method of claim 9, further including requesting user consent and storing a response to the request in the local policy table.

15. The method of claim 14, wherein the stored required consent resulted from a user consent request issued during a previous communication session between the processor and the remote application.

16. The method of claim 14, further including reporting the stored response to the remote server.

17. A non-transitory computer-readable storage medium storing instructions that, when executed by a processor, cause the processor to perform the method comprising:
receiving policy table updates issued from a remote server;
updating a local policy table based on the updates;
receiving a request from a remote application for data access;
determining, based on the local policy table, if the data access requires user consent;
determining if required consent is stored in the local policy table; and
providing data access to the remote application based on stored required consent.

18. The storage medium of claim 17, wherein the remote server is an OEM-controlled server.

19. The storage medium of claim 17, wherein the policy table updates include changes in secure data definitions.

20. The storage medium of claim 19, wherein secure data definitions relate to secure data including data requiring user permission for transfer from a vehicle to a remote device.
